(19) United States
(12) Patent Application Publication
(10) Pub. No.: US 2016/0167163 A1
(43) Pub. Date: Jun. 16, 2016

(54) Friction Stir Welding Method and Friction Stir Welding Apparatus

(71) Applicant: HITACHI, LTD., Chiyoda-ku, Tokyo (JP)

(72) Inventors: Ittou SUGIMOTO, Tokyo (JP); Satoshi HIRANO, Tokyo (JP)

(21) Appl. No.: 14/903,500

(22) PCT Filed: Jul. 12, 2013
(86) PCT No.: PCT/JP2013/069094

§ 371 Date: Jan. 7, 2016

(51) Int. Cl. B23K 20/24; B23K 20/12; B23K 26/12; H05B 7/18

(52) U.S. Cl. CPC B23K 20/24; H05B 7/18; B23K 20/122; B23K 26/126

(57) ABSTRACT

A friction stir welding method for welding a member to be welded, includes a step of heating the member to be welded by an applying heat source, a step of flattening a surface of the member to be welded that has been heated, by a smoothing component, and a step of performing friction stir welding to the surface of the member to be welded that has been flattened, by a rotating tool.

### TECHNICAL FIELD

The present invention relates to friction stir welding of a metal member and a friction stir welding apparatus.

### BACKGROUND ART

Friction stir welding is a solid state welding method that stirs, by a tool, a portion that has been heated by frictional heat so that a material to be welded becomes in a plastic flow state and is welded. In a case where the friction stir welding is applied to a material having a high melting point, such as steel, a Ti alloy, or an Ni-based alloy, heat input necessary for performing a plastic flow is high and welding is difficult. For example, PTL 1 discloses a method for performing friction stir welding after preheating by an auxiliary heat source.

### CITATION LIST

### Patent Literature

PTL 1: JP 2012-40584 A

### SUMMARY OF INVENTION

### Technical Problem

Equipping an auxiliary heat source contributes to, for example, high speed welding, plank welding, and reduction of a loan applied to an apparatus. However, a member to be welded need to be heated until being red hot in order to sufficiently obtain a preheat effect. In the method described in PTL 1, there is a problem that thermal deformation and partial melting occur due to heating so that a surface shape does not become smooth and a defect easily occurs in a friction stir welding portion.

An object of the present invention is to reduce a defect in a friction stir welding portion even when the friction stir welding portion is preheated.

### Solution to Problem

To achieve the above object, the present invention provides a friction stir welding method for welding a member to be welded, the method including the steps of: heating the member to be welded by an applying heat source; flattening a surface of the member to be welded that has been heated, by a smoothing component; and performing friction stir welding to the surface of the member to be welded that has been flattened, by a rotating tool.

A friction stir welding apparatus that welds a member to be welded, includes an applying heat source that heats the member to be welded, a smoothing component that flattens a surface of the member to be welded that has been heated, and a rotating tool that performs friction stir to the surface of the member to be welded that has been flattened.

### Advantageous Effects of Invention

According to the present invention, a defect in a friction stir welding portion can be reduced ever when the friction stir welding portion is preheated.

### BRIEF DESCRIPTION OF DRAWINGS

FIGS. 1(a) and 1(b) are schematic views of a friction stir welding apparatus including a slipping contact component.

FIGS. 2(a) and 2(b) are schematic views of a friction stir welding apparatus including a rolling contact component.

FIG. 3 is a schematic view of a structure including an arc discharge heating source and a shield, the shield being integrally formed with a contact component.

FIG. 4 is a graphical representation illustrating a load to a main shaft motor of a friction stir tool.

FIG. 5 is a developed view of a smoothing component including a groove formed on a sliding surface.

### DESCRIPTION OF EMBODIMENTS

A friction stir welding apparatus according to the present invention includes a smoothing component that comes in contact with a member to be welded and smoothes the contact portion, arranged between a rotating tool and an applying heat source. The member to be welded is previously heated by the applying heat source. Apart of the member to be welded or the entire member to be welded that has been heated, comes in contact with and is pressed to the smoothing component. Since each of the member to be welded and the smoothing component relatively moves in a reverse direction, even when there is unevenness on a surface of a heating portion of the member to be welded, the unevenness is flattened so that the surface suitable to welding can be obtained.

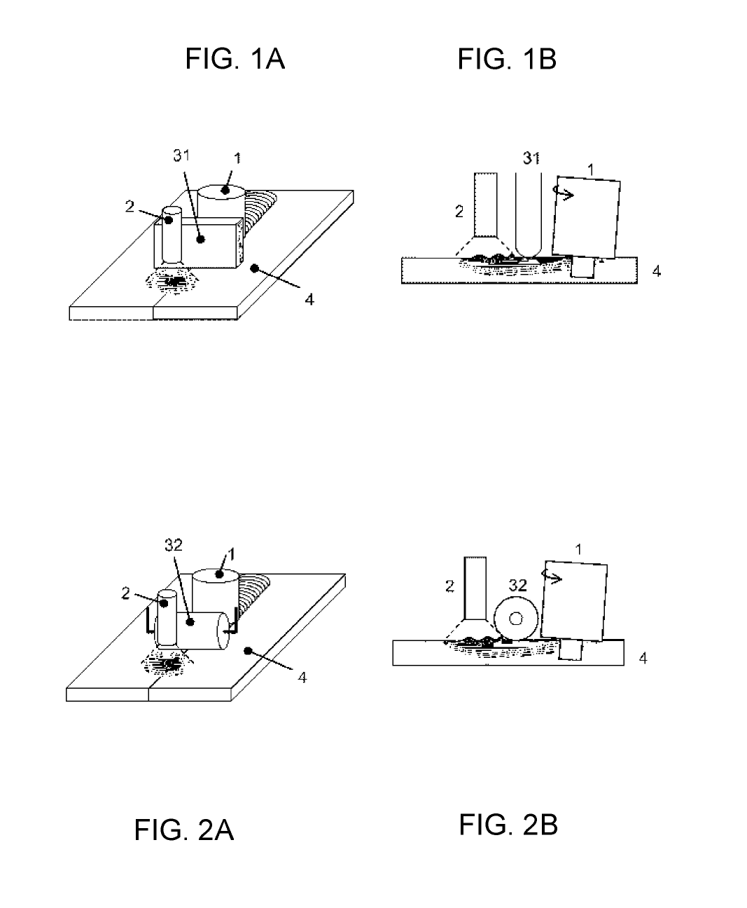

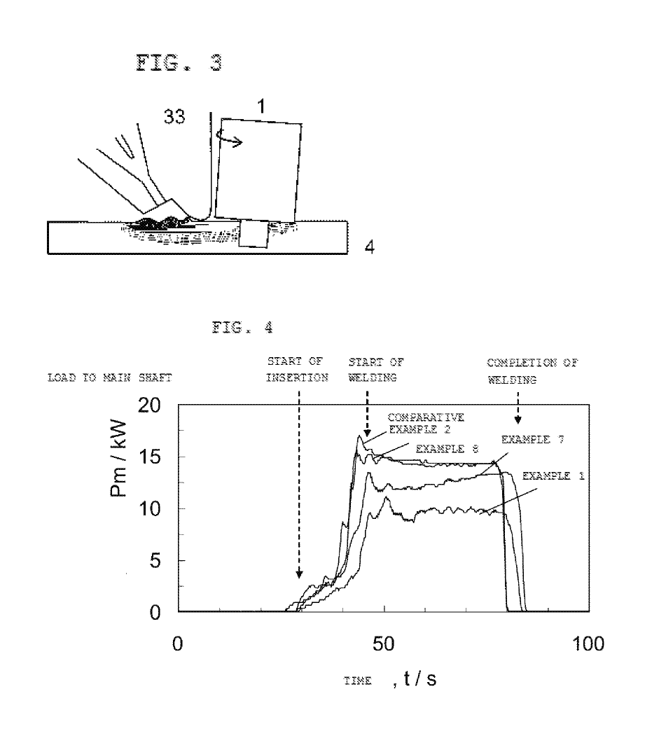

FIGS. 1 and 2 are examples of the friction stir welding according to the present invention. FIGS. 1(a) and 2(a) are perspective views and FIGS. 1(b) and 2(b) are cross-sectional views that cross respective apparatuses. Reference signs 1, 2, and 4 denote the rotating tool, the applying heat source, and the member to be welded, respectively. In FIGS. 1(a) and 1(b), the smoothing component is a slipping contact component 31, and a configuration in which an uneven surface is smoothed by sliding in contact with a sliding surface of the slipping contact component, is illustrated. A shape of the sliding surface to be in contact with the member to be welded is, for example, a plane surface, a curved surface, or a spherical surface. In FIGS. 2(a) and 2(b), the smoothing component is a rolling contact component 32, and a configuration in which a rotating body rotates while pressing unevenness down so as to smooth the uneven surface, is illustrated. Any configuration of the slipping and the rolling may be used or both of the slipping and the rolling may be used when the unevenness can be flattened. A welding boundary of the member or a portion with which the rotating tool comes in contact, may be smoothly flattened even when the entire uneven surface is not flattened. Since the applying heat source sufficiently heats the member, there is no need for heating the smoothing component for smoothing the uneven surface. In any case, the applying heat source sufficiently heats the member. Other components flatten unevenness caused by the heat so that the unevenness decreases. Thus, a surface to which friction stir welding is easily performed, is obtained. Accordingly, a defect of a friction stir welding portion can be reduced.

The rotating tool has a structure including a columnar shoulder portion on a top of the rotating tool, and a columnar probe portion having a diameter smaller than that of the shoulder portion, on a top of the shoulder portion. As examples of a material, a cemented carbide alloy, a W alloy, an Ir alloy, an Ni alloy, and a Co alloy can be used.

Examples of the applying heat source include arc discharge heating, laser heating, high frequency induction heating, resistance heating, and microwave heating. The applying heat source is not limited to these. A heating method that uses the arc discharge heating, is preferable. In a case where the arc discharge heating is used, arc discharge is Generated between an electrode and a member to be welded and then thermal energy heats the member. In this case, a part of a surrounding gas converts to plasma. Therefore, in the case where the arc discharge is used, spraying the plasma on the member to be welded can cause an effect of eliminating an air pollutant, such as an oxide film, on a surface of the member.

The applying heat source preferably includes shield equipment that confines an inert gas. In a case where, for example, a steel material is heated in an atmosphere, an oxide film is easily formed. Therefore, an oxidation reaction is preferably prevented by providing at least a surface of a heating portion with gas shield equipment and floating an inert gas inside the gas shield equipment.

In the case where the arc discharge heating is used for the applying heat source, the amount of heat input preferably satisfies that the amount of heat input H is 1 kJ/cm or more in Expression (1) below that represents heat input when arc welding is performed.

$$H = \frac{600 \times E \times I}{V} ( J \text{/} cm ) \qquad ( 1 )$$

where E, I, and V represent an arc voltage, an arc current, and a feed speed, respectively.

In this case, a center of the heating portion partially melts and then a non-uniform bulge is formed. However, the above contact component eliminates an effect of the surface shape change. A case where the amount of heat input is less than 1 kJ/cm is not preferable because a sufficient preheat effect is not obtained even though the surface shape change of the heating portion is small.

A groove may be further formed on the sliding surface of the smoothing component in a sliding direction. The groove can guide a plastic flow of the surface of the material to be welded and reduce a load to the apparatus.

Although the member to be welded is not limited to a specific material, the present invention is preferable for a case where a material having a relatively high melting point is used, and suitable to, for example, steel, a Ti alloy, a Zr alloy, an Ni alloy, and an Nb alloy.

The rotating tool, the applying heat source, and the smoothing component can be individually disposed. A structure in which the rotating tool, the applying heat source, and the smoothing component are integrally formed, can be designed. For example, in a case where a gas shield is disposed around the heating source, sliding a part of the shield together with the material to be welded can have a function of the contact component. Accordingly, the number of components can be reduced, and the heating portion and a friction stir portion are designed so as to be relatively close to each other.

### EXAMPLES

A test condition of Example 1 will be described in detail. A rotating tool was made of a sintered body of polycrystalline boron nitride (PCBN) and was molded so as to have an external shape with a probe and a shoulder. A diameter of the shoulder was set to be 17 mm. A length of the probe was set to be 3 mm. As a material to be welded, a rolled material for general structure in conformity with SS400 in JIS standard was prepared. Two plate materials that have been machined so as to have external dimensions of 100 mm×300 mm×5 mm, were butted against each other and then a welding test was performed.

As illustrated in FIGS. 1(a) and 1(b), a rotating tool, an applying heat source, and a smoothing component were arranged in a welding direction. An arc discharge torch was used for the applying heat source, and arranged so as to be apart from an outer circumferential portion of the rotating tool by 5 mm. The smoothing component was arranged between the arc discharge torch and the rotating tool. The smoothing tool was made of a cemented carbide alloy and had a configuration so as to slipping-slide with the material to be welded. A width and a length of a sliding surface were 3 mm and 20 mm, respectively. The sliding surface of the smoothing component and the shoulder of the rotating tool were arranged so as to have substantially the same height. The arc discharge torch was arranged to be higher than the sliding surface and the shoulder by 3 mm. In the welding test, the rotating tool was rotated at a position sufficiently away from the member to be welded. Then, the rotating tool was brought close to the member, and the probe was inserted into the member. Arc discharge was ignited so as to start heating immediately after the shoulder of the rotating tool and a contact component came in contact with the material to be welded. After the state was remained for 3 minutes, the rotating tool and the contact component were moved in the welding direction so as to perform butting welding. A rotational speed of the tool was selected to be 250 rpm. A tilt angle was selected to be 3°. A welding speed was selected to be in a range between 100 and 600 mm/min. A heat input condition of arc discharge heating was set so as to be approximately 2 kJ/cm.

A surface of a welded portion was observed by visual inspection so that a surface defect was evaluated. A specimen made by machining a cross-section of the welded portion, was observed by an optical microscope so that an internal defect was evaluated. The following table illustrates a list of conditions of Example 1 to Example 6, and Comparative Examples 1 and 2.

TABLE 1

| | Contact | Applying Heat | |
|---|---|---|---|
| Section | Configuration | Source | Note |
| Example 1 | Slipping | Arc Discharge | — |
| | | Heating | |
| Example 2 | Rolling | Arc Discharge | — |
| | | Heating | |
| Example 3 | Slipping | Leaser Heating | — |
| Example 4 | Slipping | High Frequency | — |
| | | Induction | |
| | | Heating | |
| Example 5 | Slipping | Arc Discharge | Entire |
| | | Heating | Equipment |
| | | | Shielded |
| Example 6 | Slipping | Arc Discharge | Shield and |
| | | Heating | Contact |
| | | | Component |
| | | | Integrally |
| | | | Formed |
| Comparative | No Contact | Arc Discharge | — |
| Example 1 | Configuration | Heating | |
| Comparative | No Contact | No Applying Heat | — |
| Example 2 | Configuration | Source | |

According to Example 1, as a result of examination by changing the welding speed, it was confirmed that a normal welded portion having no defect could be formed by a maximal speed of 500 mm/min. Meanwhile, in Comparative Example 1 without using the contact component, welding could be performed by a speed of 400 mm/min. However, as a result of a cross-section observation, it was confirmed that a defect was formed in a part of a welded portion. This is because, since friction stir welding was performed in a state where non-uniform unevenness had been formed on the surface, welding environment was unstable and the defect partially occurred. In Comparative Example 2 without using the applying heat source and the contact component, it was shown that a streaked detect occurred on the surface in a condition in which the welding speed was set to be 200 mm/min or more, and a plastic flow was insufficient.

In Example 2, as illustrated in FIGS. 2(a) and 2(b), a columnar contact component was rolling-slid so that welding was performed. In this case, it was also confirmed that a normal welded portion could be formed by a speed of 500 mm/min. As in Example 2, using a configuration of the rolling slide is expected to improve durability of the contact component.

As heating sources other than the arc discharge heating, laser heating (Example 3) and high frequency induction heating (Example 4) were examined. A welded portion having no defect could be formed even in a condition of a high welding speed like the arc discharge heating. However, it was notably confirmed that the welded portion had a mark including an oxide caught therein. The inclusion of the oxide may cause a decrease of toughness due to an intergranular fracture. Thus, the inclusion is preferably reduced. In a case where the arc discharge was used, inclusion of an oxide was less than that in a case where the laser heating or the high frequency heating was used. It can be thought that a plasma generated by arc discharge cleans the surface.

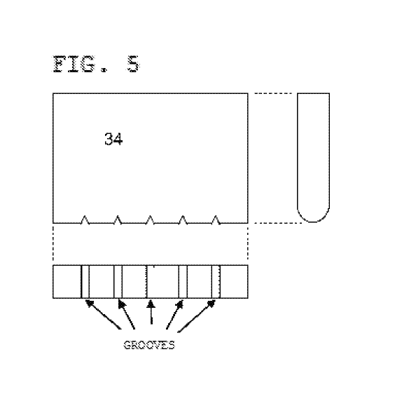

In Example 5, a surface of a material to be welded in a range of from a heating portion to a friction stir welding portion was covered with a gas shield. Argon gas was floated and welding was performed. As a result, inclusion of an oxide in the welded portion hardly occurred. In Example 6, an apparatus arrangement illustrated in FIG. 3 was adopted. In order to downside shield equipment, a heating portion was only covered with a shield. In addition, by contacting a part of the shield with a material to be welded, a smoothing component 33 having a structure in which the shield and a contact component were integrally formed, was made. In this case, inclusion of an oxide also hardly occurred like in Example 5.

Next, tests were conducted under conditions with various amounts of heat input of the arc discharge heating using the same equipment as in Example 1. Results were compared. In the following table, a list of the results is illustrated.

TABLE 2

| | | | | Maximal Speed |
|---|---|---|---|---|
| | | | Heat | at Which No |
| | Contact | Applying Heat | Input | Defect Occur |
| Section | Configuration | Source | (kJ/cm) | (mm/min) |
| Example 1 | Slipping | Arc Discharge | 2.0 | 500 |
| | | Heating | | |
| Example 7 | Slipping | Arc Discharge | 1.0 | 400 |
| | | Heating | | |
| Example 8 | Slipping | Arc Discharge | 0.75 | 150 |
| | | Heating | | |
| Comparative | No Contact | No Applying | 0.0 | 100 |
| Example 2 | Configuration | Heat Source | | |

Maximal speeds at which no defect occurred were studied by changing the welding speed. As a result, a speed of 400 mm/min was obtained in a case where the amount of heat input was 1.0 kJ/cm according to Example 7. A speed of 150 mm/min was obtained in a case where the amount of heat input was 0.75 kJ/cm according to Example 8. FIG. 4 is a graphical representation of a load to a main shaft motor that rotates a friction stir tool. According to the results, Example 1 in which the heat input was the largest achieved a load reduction of approximately 30% and Example 7 in which the amount of heat input was 1.0 kJ/cm showed a reduction of approximately 20% when compared with Comparative Example 2. In Example 8 in which the amount of heat input was 0.75 kJ/cm, it is shown that even though a peak value slightly reduced when welding was started, a level of a load hardly varied during the welding. According to the results, it can be said that the amount of heat input of the arc discharge heating is preferably set to be 1.0 kJ/cm or more.

Next, using the same equipment configuration as in Example 1, a slipping contact component including a groove formed on a sliding surface thereof was prepared and comparison was conducted. FIG. 5 is a developed view of a smoothing component used in Example 9. A groove was formed on a sliding surface of a smoothing component 34 in a sliding direction. The groove was designed so as to be triangular in cross-section and have a depth of 0.2 mm. In Example 1, a phenomenon in which the contact component largely vibrated during the welding was confirmed. However, in Example 9, it was shown that the vibration of the apparatus tended to decrease. This is because forming the groove in the sliding direction guided a plastic flow and reduced a load to the contact component. In this case, a bulge of 0.2 mm or less was formed on a surface of a member to be welded. However, no defect was formed inside a welded portion. In FIG. 5, the groove was triangular in cross-section, but the cross-section may be semicircular or square.

TABLE 3

| | Contact | Groove or | Apparatus | |
|---|---|---|---|---|
| Section | Configuration | No Groove | Vibration | Internal Defect |
| Example 1 | Slipping | No Groove | Large | No |
| | | | | Internal Defect |
| Example 9 | Slipping | Groove | Small | No |
| | | | | Internal Defect |
| Comparative | No Contact | — | — | Internal Defect |
| Example 1 | Configuration | | | |

### REFERENCE SIGNS LIST

1 rotating tool
2 applying heat source
4 member to be welded
31 slipping contact component (smoothing component)
32 rolling contact component (smoothing component)
33 shield integrated contact component (smoothing component)
34 contact component having grooves

1. A friction stir welding method for welding a member to be welded, the method comprising the steps of:
heating the member to be welded by an applying heat source;
flattening a surface of the member to be welded that has been heated, by a smoothing component; and
performing friction stir welding to the surface of the member to be welded that has been flattened, by a rotating tool.

2. The friction stir welding method according to claim 1, wherein the step of flattening causes the smoothing component to slide with respect to the member to be welded.

3. The friction stir welding method according to claim 1, wherein the step of flattening causes the smoothing component to roll in contact with the member to be welded.

4. The friction stir welding method according to claim 1, wherein the step of heating is in an inert gas.

5. The friction stir welding method according to claim 1, wherein the step of heating uses arc discharge.

6. The friction stir welding method according to claim 1, wherein the step of heating uses arc discharge, and
an amount of heat input is 1 kJ/cm or more.

7. The friction stir welding method according to claim 1, wherein the member to be welded is any of steel, Ti, a Ti alloy, Zr, a Zr alloy, an Ni alloy, and an Nb alloy.

8. A friction stir welding apparatus that welds a member to be welded, the apparatus comprising:
an applying heat source configured to heat the member to be welded;
a smoothing component configured to flatten a surface of the member to be welded that has been heated; and
a rotating tool configured to perform friction stir to the surface of the member to be welded that has been flattened.

9. The friction stir welding apparatus according to claim 8, wherein the smoothing component includes a sliding surface that slides with respect to the member to be welded.

10. The friction stir welding apparatus according to claim 8, wherein the smoothing component includes a rotating body that rotates in contact with the member to be welded.

11. The friction stir welding apparatus according to claim 8, wherein the applying heat source includes a shield that confines an inert gas.

12. The friction stir welding apparatus according to claim 8, wherein the applying heat source is arc discharge.
